(19) United States
(12) Patent Application Publication
(10) Pub. No.: US 2016/0117042 A1
(43) Pub. Date: Apr. 28, 2016

(54) DISPLAY DEVICE

(71) Applicant: Japan Display Inc., Minato-ku (JP)

(72) Inventors: Youbun ITO, Tokyo (JP); Koichiro ADACHI, Tokyo (JP)

(73) Assignee: Japan Display Inc., Minato-ku (JP)

(21) Appl. No.: 14/879,538

(22) Filed: Oct. 9, 2015

(30) Foreign Application Priority Data
Oct. 22, 2014 (JP) 2014-215612

(51) Int. Cl. G06F 3/041

(52) U.S. Cl. CPC G06F 3/0416; G06F 2203/04103; G06F 2203/04111

(57) ABSTRACT

According to one embodiment, a touch sensor includes an insulating substrate, a sensing electrode formed on the insulating substrate, and an alignment mark formed on the insulating substrate, wherein the sensing electrode is transparent, and the alignment mark is transparent and includes a slit.

### CROSS-REFERENCE TO RELATED APPLICATIONS

This application is based upon and claims the benefit of priority from Japanese Patent Application No. 2014-215612, filed Oct. 22, 2014, the entire contents of which are incorporated herein by reference.

### FIELD

Embodiments described herein relate generally to a touch sensor and a display device comprising the touch sensor.

### BACKGROUND

Recently, a touch sensor is used as an interface of a display device. As an example of the touch sensor, technology of arranging transparent conductive film patterns in a region adjacent to electrodes formed by using a transparent conductive film to reduce visibility of the electrodes is disclosed.

### BRIEF DESCRIPTION OF THE DRAWINGS

FIG. 1 is a perspective view schematically showing a structure of a display device DSP comprising a touch sensor SE.

FIG. 2 is a diagram schematically showing a basic structure and equivalent circuits of the display device DSP shown in FIG. 1.

FIG. 3 is an equivalent circuit diagram showing one of pixels PX shown in FIG. 2.

FIG. 4 is a cross-sectional view schematically showing part of the structure of the display device DSP.

FIG. 5 is a plan view schematically showing a structural example of the touch sensor SE of the embodiment.

FIG. 6 is a diagram schematically showing a connecting portion 50 between a second substrate SUB2 and a flexible printed circuit board FPC2.

FIG. 7 is a diagram schematically showing part of pads P and alignment marks M shown in FIG. 6.

FIGS. 8A, 8B, 8C, 8D, 8E and 8F are plan views schematically showing examples of a first alignment mark Ma.

FIGS. 9A and 9B are cross-sectional views showing a definition of an angle of inclination of a sensing electrode Rx and the first alignment mark Ma.

FIG. 10 is a cross-sectional view schematically showing a structure of the sensing electrode Rx and the first alignment mark Ma.

FIG. 11 is a diagram schematically showing an example of use of the first alignment mark Ma.

FIG. 12 is a diagram schematically showing an example of use of an alignment device which performs alignment based on the first alignment mark Ma.

FIG. 13 is a plan view schematically showing a structural example of the touch sensor SE.

### DETAILED DESCRIPTION

In general, according to one embodiment, a touch sensor comprises: an insulating substrate; a sensing electrode formed on the insulating substrate; and an alignment mark formed on the insulating substrate, wherein the sensing electrode is transparent, and the alignment mark is transparent and comprises a slit.

According to another embodiment, a touch sensor comprises: an insulating substrate; a sensing electrode formed on the insulating substrate, and comprising a first bottom surface facing the insulating substrate and a first side surface sloping at a first angle of inclination with respect to the first bottom surface; and an alignment mark formed on the insulating substrate, and comprising a second bottom surface facing the insulating substrate and a second side surface sloping at a second angle of inclination, which is less than the first angle of inclination, with respect to the second bottom surface, wherein the sensing electrode is transparent, and the alignment mark is transparent.

According to yet another embodiment, a display device comprises: a display panel comprising a display area and a non-display area located outside the display area; a sensing electrode located in the display area, formed on an external surface of the display panel by using a transparent material, and configured to detect an object touching or approaching the display area; and an alignment mark located in the non-display area, formed on the external surface of the display panel by using the same transparent material as the sensing electrode, and comprising a slit.

According to yet another embodiment, a display device comprises: a display panel comprising a display area and a non-display area located outside the display area; a sensing electrode located in the display area, formed on an external surface of the display panel by using a transparent material, comprising a first bottom surface facing the external surface and a first side surface sloping at a first angle of inclination with respect to the first bottom surface, and configured to detect an object touching or approaching the display area; and an alignment mark located in the non-display area, formed on the external surface of the display panel by using the same transparent material as the sensing electrode, and comprising a second bottom surface facing the external surface and a second side surface sloping at a second angle of inclination, which is less than the first angle of inclination, with respect to the second bottom surface.

The embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes and the like of the respective parts are schematically illustrated in the drawings, compared to the actual modes. However, the schematic illustration is merely an example, and adds no restrictions to the interpretation of the invention. Besides, in the specification and drawings, an element having a function equal or similar to that described in connection with preceding drawing is denoted by the same reference number, and a detailed description thereof is omitted unless otherwise necessary.

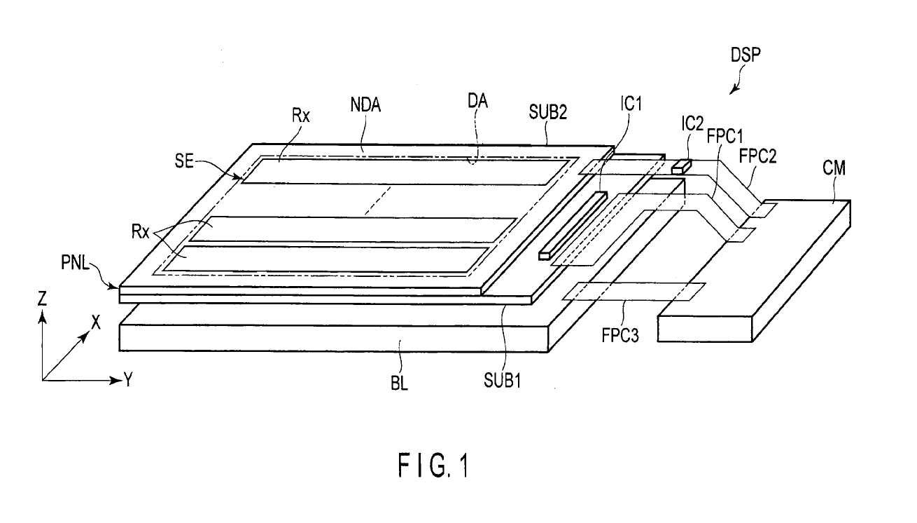

FIG. 1 is a perspective view schematically showing a structure of a display device DSP comprising a touch sensor SE. In the present embodiment, the display device comprises a liquid crystal display device. However, the display device is not limited to this and may comprise a selfluminous display panel such as an organic electroluminescent display panel, an electronic paper display panel having an electrophoretic element, or the like as a display panel.

The display device DSP comprises a display panel PNL, a driving IC chip IC1 which drives the display panel PNL, the touch sensor SE, a driving IC chip IC2 which drives the touch sensor SE, a backlight unit BL which illuminates the display panel PNL, a control module CM, flexible printed circuit boards FPC1, FPC2 and FPC3 and the like.

The display panel PNL comprises a first substrate SUB1, a second substrate SUB2 located to face the first substrate SUB1 and a liquid crystal layer (liquid crystal layer LQ to be described later) sandwiched between the first substrate SUB1 and the second substrate SUB2. The display panel PNL has a display area DA in which an image is displayed and a non-display area NDA surrounding the display area DA like a frame.

The backlight unit BL is located on the back of the first substrate SUB1. Various types of backlight units can be applied as the backlight unit BL, but explanation of a detailed structure of the backlight unit is omitted.

The sensor SE comprises sensing electrodes Rx in the display area DA. The sensing electrodes Rx are provided, for example, on the side of the display surface of the display panel PNL. In the example illustrated, the sensing electrodes Rx extend substantially in a second direction Y and are arranged in a first direction X. The sensing electrodes Rx may extend in the first direction X and be arranged in the second direction Y. The first direction X and the second direction Y are at right angles to each other. The third direction Z is at right angles to each of the first direction X and the second direction Y.

Driving IC chip IC1 is mounted on the first substrate SUB1 of the display panel PNL. Flexible printed circuit board FPC1 is mounted on the first substrate SUB1 and connects the display panel PNL and the control module CM. Flexible printed circuit board FPC2 is mounted on the second substrate SUB2 and connects the touch sensor SE and the control module CM. Driving IC chip IC2 is mounted on flexible printed circuit board FPC2. Flexible printed circuit board FPC3 connects the backlight unit BL and the control module CM. Flexible printed circuit board FPC2 may be connected to flexible printed circuit board FPC1 instead of the control module CM. Driving IC chip IC2 may be mounted on flexible printed circuit board FPC1 or may be integrated with driving IC chip IC1 and mounted on the first substrate SUB1 as a single IC chip.

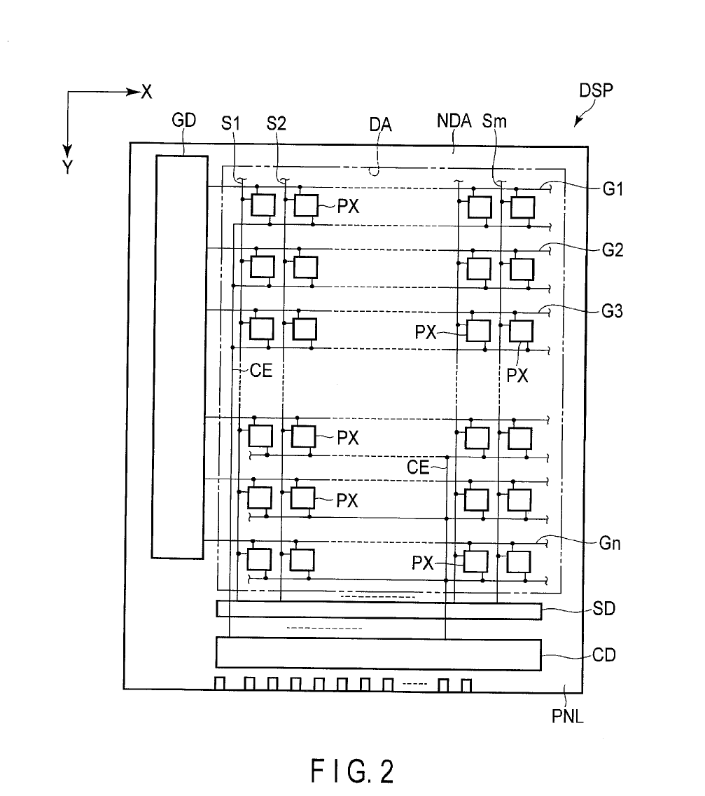

FIG. 2 is a diagram showing a basic structure and equivalent circuits of the display panel PNL shown in FIG. 1.

In addition to the display area DA, the display panel PNL comprises the non-display area NDA in which a source line driving circuit SD, a gate line driving circuit GD, a common electrode driving circuit CD and the like are provided. The source line driving circuit SD, the gate line driving circuit GD and the common electrode driving circuit CD may be formed on the first substrate SUB1, and all or part of them may be built into driving IC chip IC1.

The display panel PNL comprises pixels PX in the display area DA. The pixels PX are arrayed in a matrix in the first direction X and the second direction Y. The display panel PNL comprises gate lines G (G1 to Gn), source lines S (S1 to Sm), a common electrode CE and the like in the display area DA.

The gate lines G extend in the first direction X and are extracted outside the display area DA and connected to the gate line driving circuit GD in the non-display area NDA. The gate lines G are spaced out in the second direction Y. The source lines S extend in the second direction Y and are extracted outside the display area DA and connected to the source line driving circuit SD in the non-display area NDA. The source lines S are spaced out in the first direction X, and cross the gate lines G. The gate lines G and the source lines S do not necessarily extend linearly, and may be partly bent. The common electrode CE is extracted outside the display area DA and connected to the common electrode driving circuit CD. The common electrode CE is shared by the pixels PX. Details of the common electrode CE will be described later.

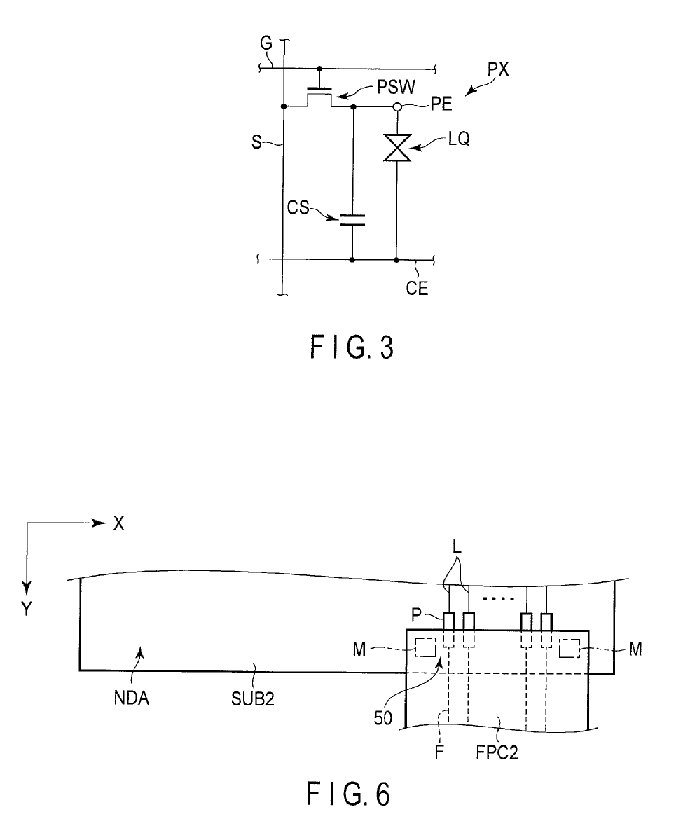

FIG. 3 is an equivalent circuit diagram showing one of the pixels PX shown in FIG. 2.

Each pixel PX comprises a switching element PSW, a pixel electrode PE, a common electrode CE, a liquid crystal layer LQ and the like. The switching element PSW is formed of, for example, a thin-film transistor (TFT). The switching element PSW is electrically connected to the gate line G and the source line S. The pixel electrode PE is electrically connected to the switching element PSW. The pixel electrode PE faces the common electrode CE and drives the liquid crystal layer LQ by using an electric field generated between the pixel electrode PE and the common electrode CE. Storage capacity CS is formed, for example, between the common electrode CE and the pixel electrode PE.

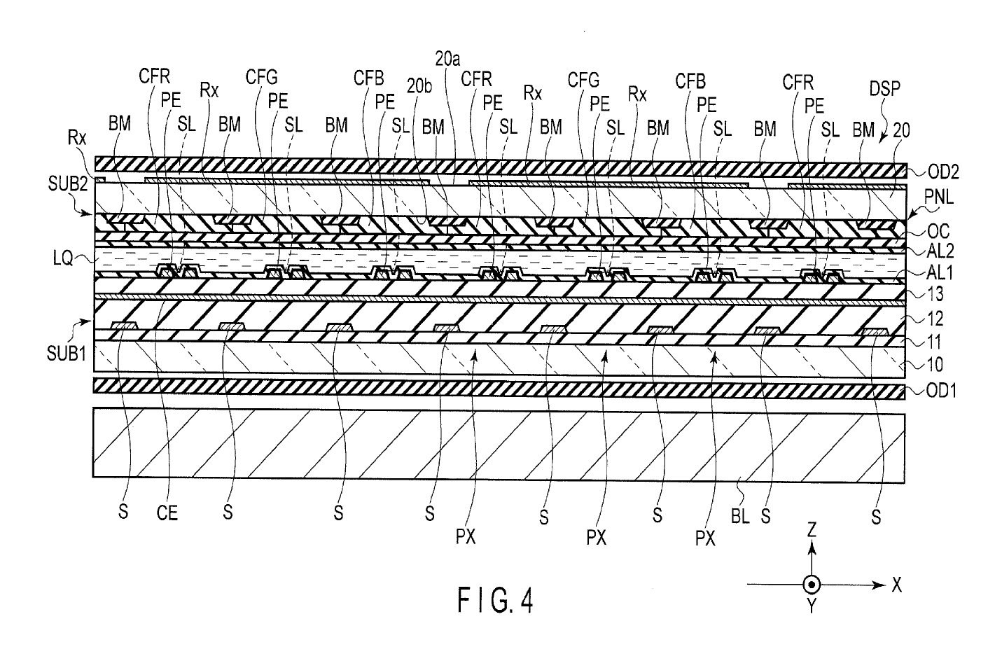

FIG. 4 is a cross-sectional view schematically showing part of the structure of the display device DSP. A cross section of the display device DSP along the first direction X is shown.

As described above, the display device DSP comprises the display panel PNL and the backlight unit BL. The illustrated display panel PNL has a structure corresponding to a display mode mainly using a lateral electric field parallel to the substrate principal surface, but the mode of the display panel PNL is not limited to this. The display panel PNL may have a structure corresponding to a display mode using a vertical electric field perpendicular to the substrate principal surface, an electric field in an oblique direction from the substrate principal surface or their combination. In the display mode using the lateral electric field, for example, a structure in which both of the pixel electrodes PE and the common electrode CE are provided on the first substrate SUB1 can be applied. In the display mode using the vertical electric field and the oblique electric field, for example, a structure in which the pixel electrodes PE are provided on the first substrate SUB1 and the common electrode CE is provided on the second substrate SUB2 can be applied. The substrate principal surface is a surface parallel to an X-Y plane defined by the first direction X and the second direction Y which are at right angles to each other.

The display panel PNL comprises the first substrate SUB1, the second substrate SUB2, and the liquid crystal layer LQ. The first substrate SUB1 and the second substrate SUB2 are bonded to each other with a predetermined gap between. The liquid crystal layer LQ is sealed in the gap between the first substrate SUB1 and the second substrate SUB2.

The first substrate SUB1 is formed by using a first insulating substrate 10 having a light transmitting property such as a glass substrate or a resin substrate. The first substrate SUB1 comprises the source lines S, the common electrode CE, the pixel electrodes PE, a first insulating film 11, a second insulating film 12, a third insulating film 13, a first alignment film AL1 and the like on the surface of the first insulating substrate 10 facing the second substrate SUB2. The switching elements, the gate lines and various insulating films between them are not shown.

The source lines S are formed on the first insulating film 11 and electrically connected to source electrodes of the switching elements provided in the pixels PX. Drain electrodes of the switching elements are also formed on the first insulating film 11.

The second insulating film 12 is provided on the source lines S and the first insulating film 11. The common electrode CE is formed on the second insulating film 12. The common electrode CE is formed of a transparent conductive material such as indium tin oxide (ITO) or indium zinc oxide (IZO). The common electrode CE is formed over the entire surface in the drawing, but may be partly removed.

The third insulating film 13 is provided on the common electrode CE and the second insulating film 12. The pixel electrodes PE are formed on the third insulating film 13. The pixel electrode PE of each pixel is located between adjacent source lines S, and faces the common electrode CE with the third insulating film 13 in between. In addition, each pixel electrode PE comprises a slit SL at a position facing the common electrode CE. The pixel electrodes PE are formed of, for example, a transparent conductive material such as ITO or IZO. The first alignment film AL1 covers the pixel electrodes PE and the third insulating film 13.

The second substrate SUB2 is formed by using a second insulating substrate 20 having a light transmitting property such as a glass substrate or a resin substrate. The second substrate SUB2 comprises a black matrix BM, color filters CFR, CFG and CFB, an overcoat layer OC, a second alignment film AL2 and the like on the surface of the second insulating substrate 20 facing the first substrate SUB1.

For example, the second substrate SUB2 comprises the sensing electrodes Rx on the side of a first principal surface 20a which is the opposite surface of the surface of the second insulating substrate 20 facing the first substrate SUB1 and corresponds to the external surface of the second insulating substrate 20. In the example illustrated, the sensing electrodes Rx are in contact with the first principal surface 20a. However, an insulating member may be provided between the first principal surface 20a and the sensing electrodes Rx. The sensing electrodes Rx are formed of a transparent conductive material. The transparent conductive material is an oxide material such as ITO or IZO. The oxide material should preferably include at least one of indium, tin, zinc, gallium and titanium. The transparent conductive material is not limited to the oxide material and may be a conductive organic material, fine dispersions of conducting substance or the like.

The black matrix BM is formed on a second principal surface 20b of the second insulating substrate 20 facing the first substrate SUB1 and partitions the respective pixels. Color filters CFR, CFG and CFB are formed on the second principal surface 20b of the second insulating substrate 20 and partly overlap the black matrix BM. Color filters CFR are red color filters arranged in pixels displaying a red color and are formed of a red resin material. Color filters CFG are green color filters arranged in pixels displaying a green color and are formed of a green resin material. Color filters CFB are blue color filters arranged in pixels displaying a blue color and are formed of a blue resin material. A pixel displaying a white color or a transparent color filter may be added. Color filters CFR, CFG and CFB may be formed on the first substrate SUB1. The overcoat layer OC covers color filters CFR, CFG and CFB. The overcoat layer OC is formed of a transparent resin material. The second alignment film AL2 covers the overcoat layer OC.

A first optical element OD1 is provided between the first insulating substrate 10 and the backlight unit BL. A second optical element OD2 is provided above the sensing electrodes Rx. Each of the first optical element OD1 and the second optical element OD2 includes at least a polarizer and may include a retardation film as needed. The polarizer included in the first optical element OD1 and the polarizer included in the second optical element OD2 are located such that their absorption axes are in a positional relationship of crossed Nicols, i.e., at right angles to each other.

Next, a structural example of the touch sensor SE mounted in the display device DSP of the present embodiment will be described. The touch sensor SE described hereinafter is, for example, a capacitive type, and detects contact or approach of an object based on variations in capacitance between electrodes facing each other through a dielectric.

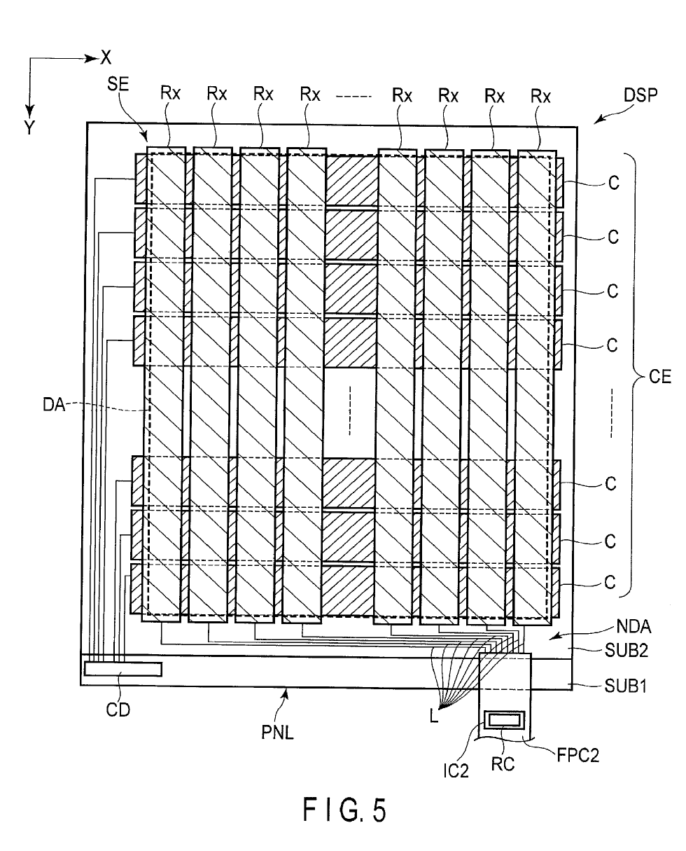

FIG. 5 is a plan view showing a structural example of the touch sensor SE of the present embodiment.

For example, the touch sensor SE comprises the common electrode CE on the first substrate SUB1 and the sensing electrodes Rx on the second substrate SUB2. That is, the common electrode CE functions as a sensor driving electrode in addition to functioning as an electrode for display.

The common electrode CE and the sensing electrodes Rx are arranged in the display area DA. In the example illustrated, the common electrode CE comprises divisional electrodes C spaced out in the second direction Y and extending linearly in the first direction X, in the display area DA. The sensing electrodes Rx are spaced out in the first direction X and extending linearly in the second direction Y in the display area DA. In other words, the sensing electrodes Rx extend in the direction crossing the divisional electrodes C. The common electrode CE faces the sensing electrodes Rx with various dielectrics (the third insulating film 13, the first alignment film AL1, the liquid crystal layer LQ, the second alignment film AL2, the overcoat layer OC, color filters CFR, CFG and CFB, the second insulating substrate 20 and the like shown in FIG. 4) in between. The display area DA may comprise an antireflection film covering the sensing electrodes Rx and the second substrate SUB2 in order to reduce visibility of the sensing electrodes Rx. The antireflection film may extend to the non-display area NDA. The common electrode CE and the sensing electrodes Rx may be provided in the non-display area NDA in order to detect contact or approach of an object in the non-display area NDA.

Each divisional electrode C is electrically connected to the common electrode driving circuit CD. The common electrode driving circuit CD supplies the common electrode CE with a common driving signal at the display driving for displaying an image, and with a sensor driving signal at the sensing driving for sensing an object. In contrast with the sensing electrodes Rx, the common electrode CE is often called a driving electrode Tx. The common electrode CE is provided across pixels arranged in the second direction Y. In FIG. 2, for example, the single common electrode CE is provided for pixels connected to gate lines G1, G2 and G3. The single common electrode CE may be provided for pixels connected to source lines, for example, source lines S1 and S2. The common electrode driving circuit CD is provided across the display panel in the first direction X in FIG. 2, but may be provided at the end of the first substrate SUB1 as shown in FIG. 5.

Leads L are provided in the non-display area NDA and electrically connected to the sensing electrodes Rx, respectively. Each lead L transmits a potential of the corresponding sensing electrode Rx which varies according to the supply of a sensor driving signal to each divisional electrode C at the sensing driving. For example, the leads L are provided on the second substrate SUB2 in a similar way to the sensing electrodes Rx.

The flexible printed circuit board FPC2 is connected to the second substrate SUB2 and electrically connected to each sensing electrode Rx. In the example illustrated, the flexible printed circuit board FPC2 is connected to the sensing electrodes Rx via the leads L. However, the leads L may be omitted and the flexible printed circuit board FPC2 may be directly electrically connected to the sensing electrodes Rx.

A sensing circuit RC is built in, for example, driving IC chip IC2. The sensing circuit RC detects an object touched or approached the sensing electrodes Rx. The sensing circuit RC can also obtain data on a position the object has touched or approached.

The structure of the touch sensor SE is not limited to the above-described example. For example, the touch sensor SE is not limited to a sensor using a mutual capacitance sensing method of detecting an object based on variations in capacitance between a pair of electrodes (in the above example, capacitance between the common electrode CE and the sensing electrodes Rx), and may be a sensor using a self capacitance sensing method of detecting an object based on variations in capacitance of the sensing electrodes Rx. The shape of each sensing electrode Rx is not limited to a strip extending linearly in the second direction Y, and may include a wavy line or a zigzag line. Island shaped sensing electrodes Rx may be arrayed in a matrix. The common electrode CE is not limited to the strip-shaped divisional electrodes C extending in the first direction X, but may be a single planar electrode continuously formed in the display area DA. When the divisional electrodes C extend substantially linearly in the second direction Y, the sensing electrodes Rx may extend substantially linearly in the first direction X.

FIG. 6 is a diagram schematically showing a connecting portion 50 between the second substrate SUB2 and the flexible printed circuit board FPC2.

At the connecting portion 50 in the non-display area NDA, the flexible printed circuit board FPC2 is aligned based on alignment marks M and connected to the second substrate SUB2. Each pad P extends in the second direction Y. The pads P are arranged in the first direction X. The alignment marks M are provided close to the pads P. In the example illustrated, two alignment marks M are provided, and the pads arranged in the first direction X are located between the two alignment marks M.

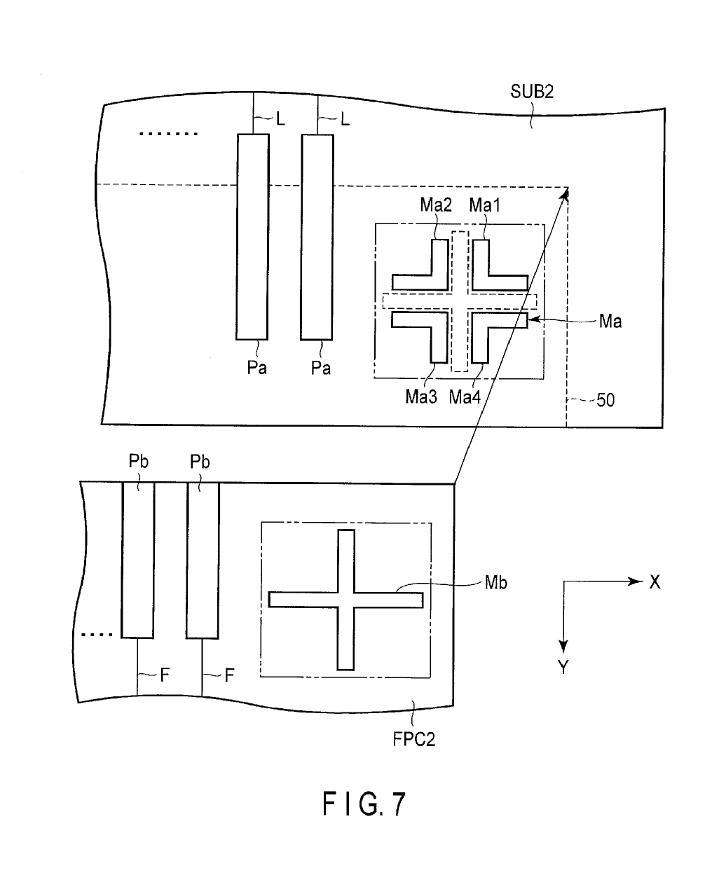

FIG. 7 is a diagram schematically showing part of the pads P and the alignment marks M shown in FIG. 6. In FIG. 7, one of the two alignment marks M is shown.

Each pad P is constituted by a first pad Pa formed on the second substrate SUB2 and a second pad Pb formed on the flexible printed circuit board FPC2. The first pads Pa are electrically connected to the leads L (or sensing electrodes Rx), respectively. For example, the leads L and the first pads Pa are formed integral with the sensing electrodes Rx by using the same material as the sensing electrodes Rx (i.e., transparent conductive material). The second pads Pb are electrically connected to traces F on the side of the flexible printed circuit board FPC2, respectively. The first pads Pa and the second pads Pb are electrically connected to each other via, for example, an anisotropic conductive film. For example, the shape of each first pad Pa and second pad Pb is rectangular, but is not limited to this and may be variously changed.

Each alignment mark M is constituted by first alignment marks Ma formed on the second substrate SUB2 and a second alignment mark Mb formed on the flexible printed circuit board FPC2. The first alignment marks Ma and the second alignment mark Mb are used as a guide to align the second substrate SUB2 and the flexible printed circuit board FPC2. The first alignment marks Ma are formed of the same transparent conductive material as the sensing electrodes Rx and at the same time as the sensing electrodes Rx.

For example, each first alignment mark Ma is L-shaped. In the example illustrated, four first alignment marks Ma1, Ma2, Ma3 and Ma4 are arranged. First alignment mark Ma1 and first alignment mark Ma4 are spaced out in the second direction Y. First alignment mark Ma1 and first alignment mark Ma2 are spaced out in the first direction X. First alignment mark Ma2 and first alignment mark Ma4 are spaced out in the second direction Y. First alignment mark Ma3 and first alignment mark Ma4 are spaced out in the first direction X. In other words, a cross-shaped gap extending in the first direction X and the second direction Y is provided between first alignment marks Ma1 to Ma4.

The second alignment mark Mb has a cross shape extending in the first direction X and the second direction Y. The flexible printed circuit board FPC2 comprising the second alignment mark Mb is aligned such that the second alignment mark Mb overlaps the cross-shaped gap between the first alignment marks Ma. After the alignment, the flexible printed circuit board FPC2 is thermally bonded to the second substrate SUB2 and electrically and mechanically connected to the second substrate SUB2.

The shape, layout and number of the first and second alignment marks Ma and Mb are not limited to the illustrated example, as long as a relative positional relationship between the second substrate SUB2 and the flexible printed circuit board FPC2 can be determined.

Next, examples of the shape of each first alignment mark Ma are described.

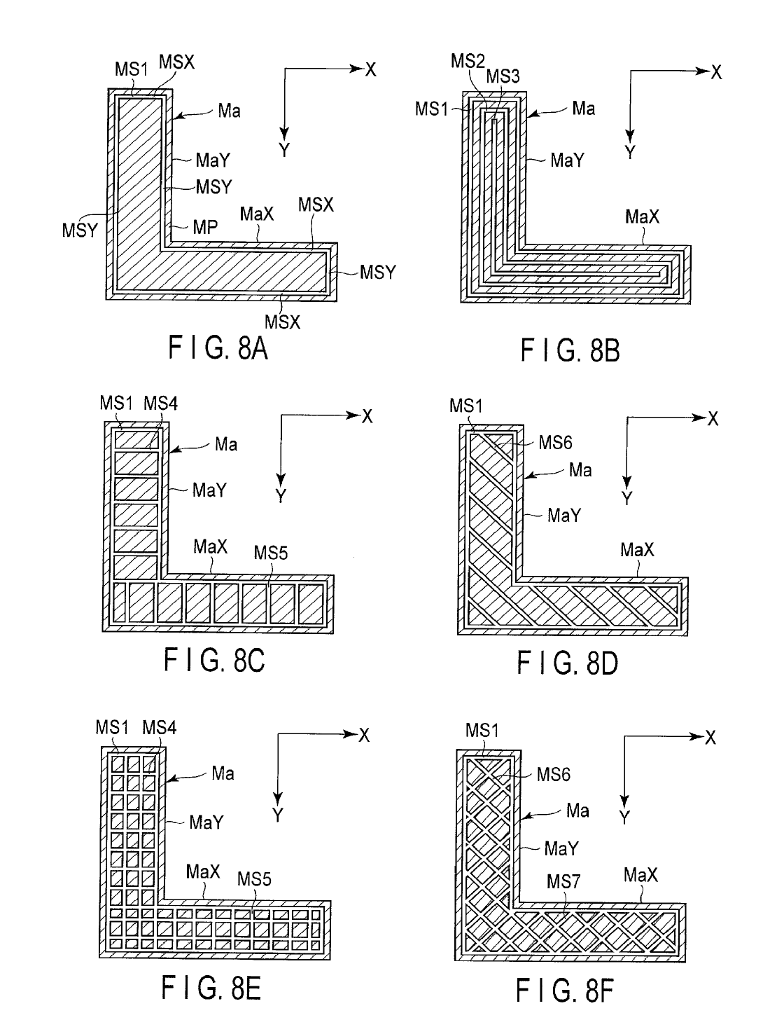

FIG. 8A to FIG. 8F are plan views showing examples of the first alignment mark Ma. The first alignment mark Ma shown in FIG. 8A to FIG. 8F corresponds to first alignment mark Ma1 shown in FIG. 7. In each example, the first alignment mark Ma is L-shaped and comprises a first region MaX extending in the first direction X and a second region MaY extending in the second direction Y.

In the example of FIG. 8A, the first alignment mark Ma comprises a first slit MS1 extending along an outline MP. The first slit MS1 includes first portions MSX formed along portions of the outline MP extending in the first direction X, and second portions MSY formed along portions of the outline MP extending in the second direction Y. In the example illustrated, the first slit MS1 is formed into the shape of a loop in which the first portions MSX and the second portions MSY are connected.

In the first alignment mark Ma, for example, the first region MaX of has a length of 200 to 300 μm in the first direction X and a width of about 50 μm in the second direction Y. The second region MaY has a length of 200 to 300 μm in the second direction Y and a width of about 50 μm in the first direction X.

With respect to the first slit MS1, for example, the first portions MSX are formed 5 to 15 μm inside the outline MP in the second direction Y. For example, the second portions MSY are formed 5 to 15 μm inside the outline MP in the first direction X. The first slit MS1 has a substantially constant width of 5 to 15 μm, for example, 7 μm. It should be noted that the first direction X and the second direction Y are not limited to directions expressed by arrows and include 180-degree directions of the arrows in the specification.

In the example of FIG. 8B, the first alignment mark Ma comprises a second slit MS2 and a third slit MS3 in addition to the first slit MS1. The second slit MS2 is located inside the first slit MS1 and formed into the shape of a loop in a similar way to the first slit MS1. The third slit MS3 is located inside the second slit MS2 and is L-shaped. The second slit MS2 is about 5 to 15 μm distant from the first slit MS1. The third slit MS3 is about 5 to 15 μm distant from the second slit MS2.

In the example of FIG. 8C, the first alignment mark Ma comprises fourth slits MS4 and fifth slits MS5 in addition to the first slit MS1. The fourth slits MS4 are formed in the second region MaY, extending in the first direction X and arranged in the second direction Y. The fifth slits MS5 are formed in the first region MaX, extending in the second direction Y and arranged in the first direction X. Adjacent fourth slits MS4 are arranged at an interval of 5 to 15 μm. Adjacent fifth slits MS5 are arranged at an interval of 5 to 15 μm.

In the example of FIG. 8D, the first alignment mark Ma comprises sixth slits MS6 in addition to the first slit MS1. The sixth slits MS6 extend obliquely with respect to the first direction X and the second direction Y. The sixth slits MS6 are arranged in a direction perpendicular to the direction of extension of the sixth slits MS6. Adjacent sixth slits MS6 are arranged at an interval of 5 to 15 μm. The sixth slits MS6 are inclined at an angle of 45° with respect to the first direction X in the drawing, but may be inclined at any angle from 20 to 70°. The shape of the sixth slits MS6 may be inverted relative to the second direction Y.

In the example of FIG. 8E, the first alignment mark Ma comprises fourth slits MS4 and fifth slits MS5 in addition to the first slit MS1. The fourth slits MS4 and the fifth slits MS5 cross each other in a lattice shape. In other words, the first alignment mark Ma is separated like islands by the first slit MS1, the fourth slits MS4 and the fifth slits MS5.

In the example of FIG. 8F, the first alignment mark Ma comprises sixth slits MS6 and seventh slits MS7 in addition to the first slit MS1. The seventh slits MS7 extend in a direction crossing the sixth slits MS6. The seventh slits MS7 are arranged in a direction perpendicular to the direction of extension of the seventh slits MS7. Adjacent seventh slits MS7 are arranged at an interval of 5 to 15 μm. The sixth slits MS6 and the seventh slits MS7 cross each other in a lattice shape. The first alignment mark Ma is separated like islands by the first slit MS1, the sixth slits MS6 and the seventh slits MS7. In a similar way to the example of FIG. 8D, the sixth slits MS6 are inclined at any angle from 20 to 70° with respect to the first direction X. The shape of the sixth slits MS6 may be inverted relative to the second direction Y. The sixth slits MS6 and the seventh slits MS7 need not be at right angles to each other and may cross at an angle other than 90°.

In the examples shown in FIG. 8E and FIG. 8F, the shape of each region separated by slits MS is a rectangle, but may be a rounded rectangle or a circle.

The first to seventh slits MS1 to MS7 are not limited to the examples illustrated and may be arbitrarily combined. A slit having a shape different from the illustrated first to seventh slits MS1 to MS7 may be applied. Each of the first slit MS1 and the second slit MS2 may be a continuous loop or be partly discontinuous in the first direction X and the second direction Y. Each of the first to seventh slits MS1 to MS7 is not necessarily a straight line and may be a curved line such as a wavy line or a zigzag line.

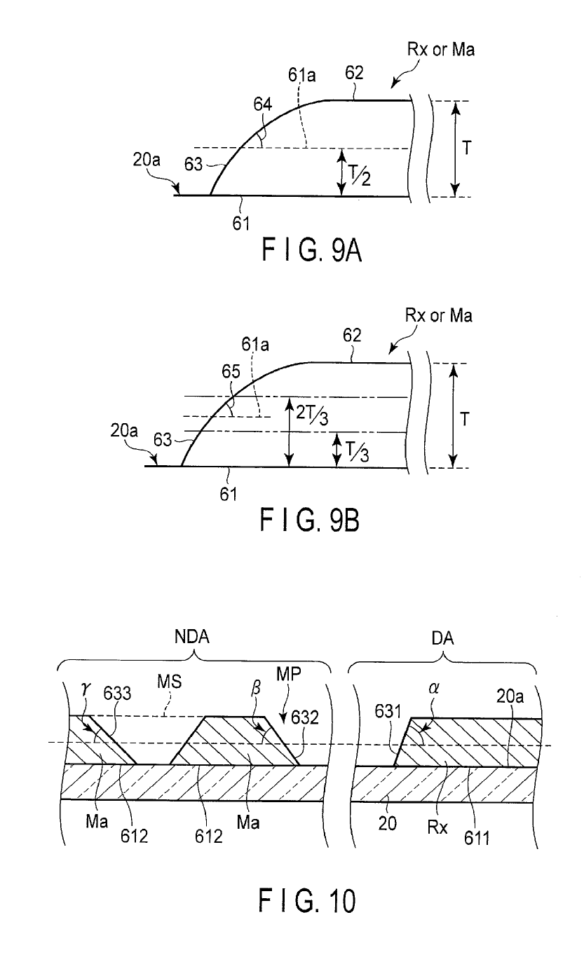

FIG. 9A and FIG. 9B are cross-sectional views showing a definition of an angle of inclination of the sensing electrodes Rx and the first alignment marks Ma.

Each sensing electrode Rx and first alignment mark Ma comprises a bottom surface 61 facing the first principal surface 20a of the second insulating substrate 20, a top surface 62 opposite to the bottom surface 61 and a side surface 63 connecting the bottom surface 61 and the top surface 62. The side surface 63 slopes at an acute angle of inclination with respect to the bottom surface 61.

The definition of the angle of inclination is described. The side surface 63 is not necessarily flat and may be curved. Therefore, on the assumption that the thickness of the sensing electrode Rx or the first alignment mark Ma is T, an angle of inclination 64 is defined as an angle of the side surface 63 with respect to the bottom surface 61 at a position half the thickness T from the bottom surface 61 in the normal direction in the present embodiment, as shown in FIG. 9A. A dashed line 61a in the drawings represents a surface parallel to the bottom surface 61. As shown in FIG. 9B, an angle of inclination 65 may be defined as an angle of the side surface 63 with respect to the bottom surface 61 in a range from a position one-third the thickness T to a position two-thirds the thickness T from the bottom surface 61 in the normal direction.

FIG. 10 is a cross-sectional view schematically showing a structure of the sensing electrodes Rx and the first alignment marks Ma.

Each sensing electrode Rx comprises a first bottom surface 611 and a first side surface 631. The first bottom surface 611 faces the first principal surface 20a corresponding to the external surface of the second insulating substrate 20. The first side surface 631 slopes at a first angle of inclination α with respect to the first bottom surface 611.

Each first alignment mark Ma in the non-display area NDA comprises a second bottom surface 612 and a second side surface 632. The second bottom surface 612 faces the first principal surface 20a. The second side surface 632 forms the outline MP of the first alignment mark Ma and slopes at a second angle of inclinationβ with respect to the second bottom surface 612. In the present embodiment, the second angle of inclination β is less than the first angle of inclination α.

Each first alignment mark Ma further comprises a third side surface 633 in the slit MS. The third side surface 633 slopes at a third angle of inclination γ, which is less than the first angle of inclination α, with respect to the second bottom surface 612. The third angle of inclination γ may be equal to the second angle of inclination β.

Each of the illustrated first to third angles of inclination α, β and γ corresponds to the angle of inclination 64 defined in FIG. 9A, but may be the angle of inclination 65 defined in FIG. 9B. In either case, each of the first to third angles of inclination α, β and γ is an acute angle less than 90°.

Such sensing electrodes Rx and first alignment marks Ma can be formed by, for example, forming a film of a transparent material on the first principal surface 20a and then etching the film by using a resist formed to have a desired pattern. At this time, the first side surfaces 631 at the first angle of inclination α of the sensing electrodes Rx, and the second side surfaces 632 at the second angle of inclination β and the third side surfaces 633 at the third angle of inclination γ of the first alignment marks Ma can be formed in the same process by adjusting the thickness of the resist and the etching condition. However, the sensing electrodes Rx and the first alignment marks Ma may be formed in different etching processes.

Since the sensing electrodes Rx are located in the display area DA, the visibility of the sensing electrodes Rx is required to be reduced to a minimum even if the sensing electrodes Rx are formed of a transparent material. In contrast, since the first alignment marks Ma necessary for aligning the flexible printed circuit board FPC2 and the second substrate SUB2 are formed of the same transparent material as the sensing electrodes Rx, the visibility of the first alignment marks Ma is required to be improved. A specific example of the first angle of inclination α and the second angle of inclination β for satisfying these requirements is hereinafter described.

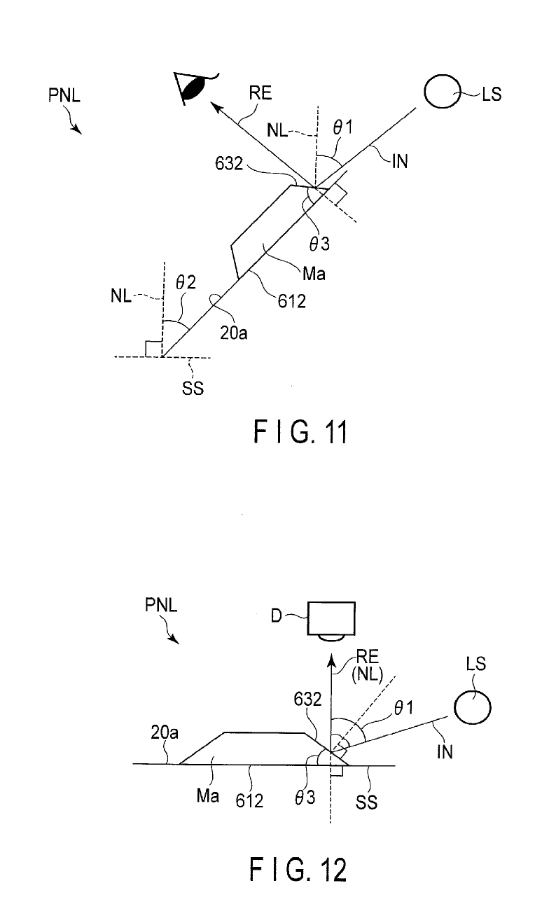

FIG. 11 is a diagram showing an example of use of the first alignment mark Ma.

A first angle θ1 is an angle formed by a direction of a normal line NL of a reference plane SS and a direction of incident light IN from a light source LS to the second side surface 632. A second angle θ2 is an angle formed by the normal line NL and the second bottom surface 612 (or the first principal surface 20a). A third angle θ3 is an angle formed by the second side surface 632 and the second bottom surface 612. The third angle θ3 is an angle corresponding to the above-described second angle of inclination β, but may be considered as an angle corresponding to the third angle of inclination γ. The first angle θ1 is from 0 to 45°. The second angle θ2 is from 0 to 90°. On the assumption that the user watches the display panel PNL from the front (i.e., a normal direction of the first principal surface 20a), reflected light RE of the second side surface 632 is directed to the position of the user on the following condition:

θ3=(90°+θ1−θ2)/2

If the first angle θ1=45° and the second angle θ2=0° on the above condition, the third angle θ3 is 67.5°. If the positional relationship between the light source LS and the display panel PNL is maintained and the first angle θ1 is 45°, the third angle θ3 decreases from 67.5° as the second angle θ2 increases from zero. That is, in such an example of use, the visibility of the first alignment mark Ma by the user can be increased by setting an angle greater than zero but not greater than 67.5° as the third angle θ3.

In other words, if an angle greater than 67.5° is set as the third angle θ3, the reflected light RE hardly reaches the user. Since the visibility of the sensing electrodes Rx are required to be reduced, the first angle of inclination α of the first side surface 631 should preferably be an angle greater than 67.5° but not greater than 90°.

FIG. 12 is a diagram showing an example of use of an alignment device which performs alignment based on the first alignment mark Ma.

The alignment device comprises a light source LS and a detector D. The detector D is, for example, a camera which optically detects the first alignment mark Ma illuminated with light from the light source LS, and is located in a direction of a normal line NL of a reference plane SS. At this time, the display panel PNL is parallel to the reference plane SS.

A first angle θ1 is an angle formed by the direction of the normal line NL of the reference plane SS and a direction of incident light IN from the light source LS to the second side surface 632. A third angle θ3 is an angle formed by the second side surface 632 and the second bottom surface 612 (i.e., an angle corresponding to the second angle of inclination β). An incidence angle of the incident light IN with the second side surface 632 is equal to the third angle θ3 and half the first angle θ1. That is, in such an example of use, reflected light RE of the second side surface 632 is directed to the position of the detector D on the following condition:

θ3=θ1/2

If the first angle θ1 is from 0 to 90° on the above condition, the third angle θ3 is 45° or less. Furthermore, if the first angle θ1 is from 45 to 60°, the third angle θ3 is from 22.5 to 30°. That is, in such an example of use, the first alignment mark Ma can be reliably detected regardless of what alignment device is used, by setting an angle greater than zero but not greater than 45° as the third angle θ3. In a more realistic alignment device, the first alignment mark Ma can be reliably detected by setting an angle from 22.5 to 30° as the third angle θ3.

According to the present embodiment, the first alignment marks Ma are formed of the same material and on the same surface as the sensing electrodes Rx (in the above example, the first principal surface 20a). Therefore, the first alignment marks Ma can be formed in the same process as the sensing electrodes Rx. Each first alignment mark Ma comprises a slit MS. Accordingly, each first alignment mark Ma comprises not only a second side surface 632 along the outline MP but also a third side surface 633 along the slit MS. As a result, each first alignment mark Ma of the present embodiment comprises more side surfaces than an alignment mark without a slit. When the first alignment marks Ma are illuminated with light, the light is reflected from the second side surfaces 632 and the third side surfaces 633. The visibility of the first alignment marks Ma is thereby improved.

Therefore, the first alignment marks Ma on the second substrate SUB2 and the second alignment mark Mb on the flexible printed circuit board FPC2 can be easily aligned when connecting the flexible printed circuit board FPC2 to the second substrate SUB2. Since the visibility of the first alignment marks Ma is improved, the flexible printed circuit board FPC2 and the sensing electrodes Rx can be easily electrically connected.

Each first alignment mark Ma comprises a looped slit MS. Therefore, adequate reflected light can be obtained regardless of the irradiation direction of light toward the first alignment marks Ma, which contributes the improvement in visibility of the first alignment marks Ma.

With a current processing accuracy, the first slit MS1 can be formed without being connected with the outline MP of the first alignment mark Ma1 if a distance between the outline MP and the first slit MS1 is 5 μm or more. The visibility of the outline MP can be improved if the distance between the outline MP and the first slit MS1 is 15 μm or less. The slits are not connected with each other and a fault such as peeling of a first alignment mark Ma between the slits from the second insulating substrate 20 can be reduced if a distance between adjacent slits is 5 μm or more. With a current processing accuracy, each slit can be continuously formed if the width of each slit is 5 μm or more. The area of the first alignment mark Ma can be prevented from being reduced if the width of each slit is 15 μm or less.

According to the present embodiment, the second angle of inclination β of the second side surface 632 in the outline MP of each first alignment mark Ma is less than the first angle of inclination α of the first side surface 631 of the sensing electrode Rx. As described above, the visibility of a side surface is increased as an angle of inclination of the side surface is decreased, and the visibility of the side surface is decreased as the angle of inclination of the side surface is increased. Therefore, with respect to the sensing electrodes Rx and the first alignment marks M formed of the same material, the visibility of the sensing electrodes Rx can be reduced and the visibility of the first alignment marks Ma can be improved.

In the slit MS of each first alignment mark Ma, the third angle of inclination γ of the third side surface 633 is less than the first angle of inclination α. That is, a side surface at a less angle of inclination is added to each first alignment mark Ma by virtue of the slit MS, which further improves the visibility of the first alignment marks Ma.

In one example, the visibility of the sensing electrodes Rx can be sufficiently reduced if the first angle of inclination α of the sensing electrodes Rx is greater than 67.5° but not greater than 90°. In contrast, the visibility of the first alignment marks Ma can be improved if the second angle of inclination β and the third angle of inclination γ of the first alignment marks Ma are greater than zero but not greater than 67.5°.

In another example, the visibility of the first alignment marks Ma can be improved if the second angle of inclination β and the third angle of inclination γ are greater than zero but not greater than 45°, preferably from 22.5 to 30°.

Next, a touch sensor SE of a modified embodiment of the present embodiment is described.

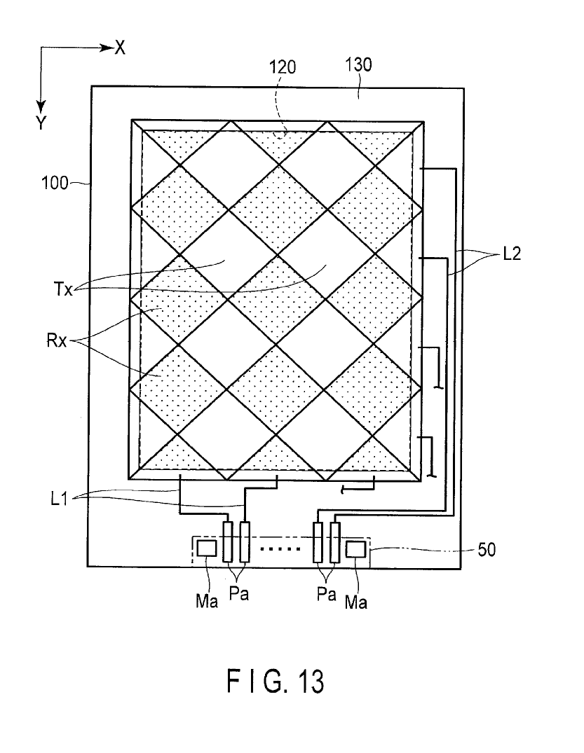

FIG. 13 is a plan view schematically showing a structural example of the touch sensor SE. The touch sensor SE is an out-cell type attached to the side of the display surface of the display panel.

The touch sensor SE is formed by using an insulating substrate 100 having a light transmitting property such as a glass substrate or a resin substrate. The touch sensor SE comprises an input region 120 and a peripheral region 130 surrounding the input region 120. The input region 120 faces the display area of the display device when the touch sensor SE is attached to the display device.

For example, the touch sensor SE comprises sensing electrodes Rx, sensor driving electrodes Tx and first alignment marks Ma on a principal surface of the insulating substrate 100. The sensing electrodes Rx and the sensor driving electrodes Tx are located in the input region 120. The sensing electrodes Rx are electrically connected to first pads Pa via leads L1 located in the peripheral region 130. The sensor driving electrodes Tx are electrically connected to first pads Pa via leads L2 located in the peripheral region 130. The first alignment marks Ma are located in the peripheral region 130.

Each sensing electrode Rx and sensor driving electrode Tx is quadrangular. Sensing electrodes Rx arranged in the second direction Y are electrically connected to each other, and sensing electrodes Rx arranged in the first direction X are electrically insulated from each other. Sensor driving electrodes Tx arranged in the first direction X are electrically connected to each other, and sensor driving electrodes Tx arranged in the second direction Y are electrically insulated from each other. The sensing electrodes Rx and the sensor driving electrodes Tx are formed of a transparent conductive material (for example, ITO), and electrically insulated from each other by an insulating film (not shown).

The first alignment marks Ma are formed of a transparent conductive material (for example, ITO), and can be formed in the same process as the sensing electrodes Rx or the sensor driving electrodes Tx.

In such a modified embodiment, the visibility of the first alignment marks Ma can be improved by providing the first alignment marks Ma with slits, in a similar way to the above-described embodiment. Since each sensing electrode Rx and sensor driving electrode Tx has a first side surface at a first angle of inclination and each first alignment mark Ma has a second side surface at a second angle of inclination which is less than the first angle of inclination, the visibility of the sensing electrodes Rx and the sensor driving electrodes Tx can be reduced and the visibility of the first alignment marks Ma can be improved. Therefore, the same effect as the above-described embodiment can be achieved. The touch sensor SE may be configured such that the sensing electrodes Rx are formed on one principal surface of the insulating substrate 100 and the sensor driving electrodes Tx are formed on the other principal surface of the insulating substrate 100.

As described above, according to the embodiments, a touch sensor capable of reducing the visibility of sensing electrodes and easily electrically connecting a flexible printed circuit board and the sensing electrodes, and a display device comprising the touch sensor can be provided. In the specification, alignment marks formed of the same material as the sensing electrodes are used for alignment of the flexible printed circuit board. However, the alignment marks of the embodiments can be used for alignment of other glass substrates, housing or the like. The alignment marks can be provided on not only a touchpanel but also a display panel and the like. The embodiments are not limited to alignment marks formed at the same time as sensing electrodes of a touchpanel, but may be applied to any transparent electrodes formed on a substrate and alignment marks formed at the same time as the transparent electrodes.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A touch sensor comprising:
an insulating substrate;
a sensing electrode formed on the insulating substrate; and
an alignment mark formed on the insulating substrate,
wherein the sensing electrode is transparent, and the alignment mark is transparent and comprises a slit.

2. The touch sensor of claim 1, wherein the slit extends along an outline of the alignment mark.

3. The touch sensor of claim 2, wherein the slit is formed into a shape of a loop.

4. The touch sensor of claim 1, further comprising a flexible printed circuit board mounted on the insulating substrate and electrically connected to the sensing electrode.

5. A touch sensor comprising:
an insulating substrate;
a sensing electrode formed on the insulating substrate, and comprising a first bottom surface facing the insulating substrate and a first side surface sloping at a first angle of inclination with respect to the first bottom surface; and
an alignment mark formed on the insulating substrate, and comprising a second bottom surface facing the insulating substrate and a second side surface sloping at a second angle of inclination, which is less than the first angle of inclination, with respect to the second bottom surface,
wherein the sensing electrode is transparent, and the alignment mark is transparent.

6. The touch sensor of claim 5, wherein the alignment mark comprises a slit.

7. The touch sensor of claim 6, wherein the alignment mark comprises, in the slit, a third side surface sloping at a third angle of inclination, which is less than the first angle of inclination, with respect to the second bottom surface.

8. The touch sensor of claim 6, wherein the slit extends along an outline of the alignment mark.

9. The touch sensor of claim 8, wherein the slit is formed into a shape of a loop.

10. The touch sensor of claim 5, further comprising a flexible printed circuit board mounted on the insulating substrate and electrically connected to the sensing electrode.

11. A display device comprising:
a display panel comprising a display area and a non-display area located outside the display area;
a sensing electrode located in the display area, formed on an external surface of the display panel by using a transparent material, and configured to detect an object touching or approaching the display area; and
an alignment mark located in the non-display area, formed on the external surface of the display panel by using the same transparent material as the sensing electrode, and comprising a slit.

12. The display device of claim 11, wherein the slit extends along an outline of the alignment mark.

13. The display device of claim 12, wherein the slit is formed into a shape of a loop.

14. The display device of claim 11, further comprising a flexible printed circuit board mounted on the external surface of the display panel and electrically connected to the sensing electrode.

15. A display device comprising:
a display panel comprising a display area and a non-display area located outside the display area;
a sensing electrode located in the display area, formed on an external surface of the display panel by using a transparent material, comprising a first bottom surface facing the external surface and a first side surface sloping at a first angle of inclination with respect to the first bottom surface, and configured to detect an object touching or approaching the display area; and
an alignment mark located in the non-display area, formed on the external surface of the display panel by using the same transparent material as the sensing electrode, and comprising a second bottom surface facing the external surface and a second side surface sloping at a second angle of inclination, which is less than the first angle of inclination, with respect to the second bottom surface.

16. The display device of claim 15, wherein the alignment mark comprises a slit.

17. The display device of claim 16, wherein the alignment mark comprises, in the slit, a third side surface sloping at a third angle of inclination, which is less than the first angle of inclination, with respect to the second bottom surface.

18. The display device of claim 16, wherein the slit extends along an outline of the alignment mark.

19. The display device of claim 18, wherein the slit is formed into a shape of a loop.

20. The display device of claim 15, further comprising a flexible printed circuit board mounted on the external surface of the display panel and electrically connected to the sensing electrode.
